(19) United States
(12) Patent Application Publication
(10) Pub. No.: US 2006/0176971 A1
(43) Pub. Date: Aug. 10, 2006

(54) Multi input multi output wireless communication reception method and apparatus

(76) Inventor: Daniel Nathan Nissani (Nissensohn), Tel Aviv (IL)

Correspondence Address: Daniel Nathan Nissani (Nissensohn), Ranath Aviv C, Apt. 46, Hakim St. 4, Tel Aviv, 69120, IL

(21) Appl. No.: 11/052,377

(22) Filed: Feb. 7, 2005

(51) Int. Cl. H04L 1/02; H04B 7/02

(52) U.S. Cl. 375/267

(57) ABSTRACT

A Multi Input Multi Output (MIMO) Wireless Communication Reception Method and Apparatus are proposed whereby in a 2-way wireless communication system with scattering propagation channels, where several data sub-streams are simultaneously transmitted from a transmitting side to a receiving side, and where no channel information is necessarily available at the transmitting side, excellent Symbol Error Rate performance is a achieved, in some cases quasi-optimal, at a complexity scaling at most quadratically with the number of transmitted sub-streams and independent of the constellation order.

### STATEMENT REGARDING FEDERALLY SPONSORED RESEARCH OR DEVELOPMENT

Not Applicable

### CITED REFERENCES

The following references are cited within this invention description:

Foschini, J. G., ‘Wireless communications system having a layered space-time architecture employing multi-element antennas’, U.S. Pat. No. 6,097,771

Paulraj, A. J., et al. ‘Method and wireless systems using multiple antennas and adaptive control for maximizing a communication parameter’, U.S. Pat. No. 6,351,499

Gesbert, D., Shafi, M. et al., ‘From Theory to Practice: An Overview of MIMO Space-Time Coded Wireless Systems’, IEEE Journal on Selected Areas in Communications, April 2003

Nissani (Nissensohn), D. N, ‘Multi Input Multi Output Wireless Communication Method and Apparatus providing Extended Range and Extended Rate across Imperfectly Estimated Channels’, US PTO Ser. No. 10/423,447, Apr. 28, 2003

Proakis, J. G., ‘Digital Communications’, McGraw-Hill, 1995

Van Trees, H., ‘Detection, Estimation and Modulation Theory’, Wiley, 1968

Lenstra, A. K., Lenstra, H. W., Lovasz, L., ‘Factoring Polynomials with Rational Coefficients’, Math. Annalen, vol. 261, 1982

Agrell, E., Eriksson, T., et al., ‘Closest Point Search in Lattices’, IEEE Transaction on Information Theory, August 2002

Duda, R. O., Hart, P. E., ‘Pattern Classification and Scene Analysis’, Wiley & Sons, 1973

Van Thoai, N. ‘Global Optimization Techniques for Solving the General Quadratic Integer Programming Problem’, Computational Optimization and Applications, May 1998

Hooke, R., Jeeves, T. A., ‘Direct Search solution of numerical and statistical problems’, Journal of the Association for Computing Machinery, (8), 1961

Sokolnikoff, I. S., Redheffer, R. M. ‘Mathematics of Physics and Modern Engineering’, McGraw Hill, 1966

### BACKGROUND OF THE INVENTION

This invention relates in general to Multi Input Multi Output (MIMO) 2-way Wireless Communication Systems. More specifically, this invention is related to MIMO 2-way Wireless Communication Systems where Multiple Antenna Arrays (MAA) are used in the system communication devices, where the propagation Channel Matrix is random, and where Channel State Information is not necessarily available at the Transmitter Side.

During recent years MIMO schemes were proposed for Wireless Communication Systems whereby the system communication devices include MAA and associated transmission and reception circuitry. MIMO systems, when operated in richly scattering channels (such as typical urban and indoor channels in conjunction with properly designed antenna arrays) may exhibit space diversity gain (and thus Extended Range), and, in certain cases, the ability to effectively multiply the overall data rate transferred thru the channel by means of splitting the data stream into several sub-streams, all transmitted simultaneously (and thus achieving Extended Rate). Note that while the term Extended Capacity could be used instead of both Extended Range/Rate (since in Wireless Communication Systems range can be usually traded off by rate and vice-versa) we prefer the latter distinction along this text to distinguish between the ‘conventional’ diversity gain on one hand, and the ability to transmit several data sub-streams in parallel, which may be achieved only when the 2 communicating sides include an MAA, on the other.

These MIMO schemes may be broadly classified into 2 classes: those that require Channel State Information (CSI) to be available at the Transmitting Side (e.g. [4]) prior to data sub-streams transmission and those that do not necessarily require that any CSI be available at the Transmitting Side. This proposed invention deals with MIMO schemes that belong to this second class.

The governing equation of this said class of MIMO schemes is
y_{c}=H_{c}x_{c}+n_{c} (1)
where, in complex base-band representation, H_{c} denotes the propagation complex Channel Matrix of R×L elements (the ‘c’ subscript denoting here and elsewhere the complex nature of these entities), with R and L the number of antenna elements at the (receiving) Right and (transmitting) Left sides respectively, where x_{c} is the transmitted complex base-band vector, y_{c} is the received complex base-band vector distorted by the channel H_{c} and interfered by the channel additive noise n_{c}.

It is assumed in the sequel for purpose of simplicity and without loss of generalization that the Channel Matrix elements are non frequency selective, complex Gaussian random variables with zero mean and unity variance (E[hᵢⱼ]=0; E[|hᵢⱼ|²]=1); the number of simultaneous complex sub-streams M_{c} is equal to the number of transmission elements L which in turn is equal or smaller than the number of receiving elements R, that the transmission vector elements x_{ci} are uniformly distributed, drawn from a ‘typical’ constellation (such as QPSK, 16-QAM, 64-QAM, etc.); the transmission power is constrained to unity (E[x_{c}′x_{c}]=1, where (·)′ denotes the conjugate transpose operation), and that the channel additive noise n_{c} is a complex Gaussian random variable with zero mean, i.i.d. elements and variance inversely proportional to the Receiver mean Signal to Noise Ratio (SNR) or Symbol Energy to Noise Power Density (Es/No) ([e.g. [5]), i.e. E [n_{c}]=0, E [n_{c}′n_{c}]=1/SNR=1/(Es/No).

It is further assumed in the sequel for purpose of simplicity and without loss of generalization that the Channel Matrix H_{c} is perfectly estimated at the Receiving Side prior to data sub-streams reception by some implicit Channel training stage, i.e. H_{cn}=H_{c} where H_{cn} denotes the estimated Channel Matrix and that the Channel Matrix is practically time invariant, that is only negligible changes in the matrix H_{c} occur during the duration of a transmission burst.

Several solutions have been proposed to the MIMO equation (1) above. In one such proposed solution the transmitted vector x_{c} is estimated by application of the Inverse Channel matrix (or, as is usually more appropriate, the pseudo-inverse matrix), followed by a slicing (or decision, or rounding) operation omitted herein for simplicity. This proposed method is also known as the Zero Forcing (ZF) method, is equivalent to the Least Square Estimate (LSE) method, and is considered ‘naïve’ (due to its relatively poor Symbol Error Rate (SER) vs Es/No performance), but widely used in literature (as well as herein) as a performance reference scheme. In formal notation
x_{cn}=(H_{cn}′H_{cn})⁻¹H_{cn}′y_{c} (2)
where x_{cn} denotes the estimator of the transmitted sub-streams vector x_{c}. A variant of this ZF method, Minimum Mean Square Estimate (MMSE) with somewhat better performance is used sometimes, and omitted herein for the sake of brevity. The complexity of this ZF scheme can be easily shown to be roughly quadratic with the dimension of the transmitted vector x_{c} and independent of the constellation order (QPSK, 16-QAM, etc.)

Another proposed solution (e.g. [1]) to (1) above is based on an Interference Cancellation scheme whereby sub-streams are usually ordered (according to some quality criterion) and then individually estimated, sliced and cancelled out from the sub-sequent sub-streams. This Interference Cancellation method yields better performance than (2) above, at a significant complexity penalty.

Still other proposed solution (e.g. [2]) to (1) above consists of estimating each sub-stream quality (e.g. by monitoring its SER), sending quality feedback from Receiver Side to Transmitter Side, and individually adapting the Transmitter sub-streams parameters (such as constellation type, channel code, etc.) so as to maximize the system throughput.

Still other proposed solution (e.g. [3]) to (1) above, of special relevance to our proposed invention, is the so called Maximum Likelihood Detection (MLD) scheme whereby the estimated transmitted vector x_{cn} is the vector which minimizes the (Euclidean) distance between the received vector y_{c} and the Channel transformed vector x_{c}, namely:
x_{cn}=arg min ||y_{c}−H_{cn}x_{ci}||² (3)
where the minimization process takes place upon all the candidate vectors x_{ci} (not to be confused with the transmission vector elements x_{ci}). This scheme is known to be optimal in the sense of SER vs. Es/No performance, and thus serves as a lower bound reference in literature (as well as herein). However the MLD scheme is also known (again, [3]) to be of prohibitive complexity, the number of candidate vectors x_{ci} exponentially growing with both the dimension of x_{c} and the order of the symbol constellation; for example, the detection of a transmitted vector with M_{c}=4 sub-streams (i.e. a MIMO system comprising 4 radiating elements MAA) drawn out of 64-QAM constellation, would require 2^{6×4} or approximately 16000000 operations/symbol, clearly prohibitive with present art computation devices technology.

### OBJECTIVES AND ADVANTAGES OF THE INVENTION

The main objective of the present invention is to propose a comprehensive Method and corresponding Apparatus by means of which a MIMO Reception device can achieve excellent (and quasi optimal in many cases) SER vs. Es/No performance at a computational complexity growing only quadratically with the dimension of x and practically independent of the constellation order.

A major advantage of the proposed invention is its ability to achieve excellent SER vs. Es/No performance, quasi-optimal in many cases.

Still other major advantage of the present invention is the low computational complexity implied in the realization of the Reception device.

Still another advantage of this current invention is its relevance to both MIMO systems whereby the actual transmission and reception processing is usually conducted at the Frequency Domain (such as in OFDM based systems) as well as to MIMO systems whereby said processing is executed at the Time Domain (such as short modulation symbol CDMA, or GSM systems).

Still another advantage of this proposed invention is its backward compatibility and applicability to any existing MIMO systems since its realization does not impose any changes in the structure of the transmitted signals.

Still another advantage of this invention is its applicability to both MIMO systems whereby CSI is not necessarily available at the Transmitting Side as well as MIMO systems where partial or full CSI is made available at the Transmission Side.

### SUMMARY OF THE INVENTION

The proposed invention consists of a MIMO Reception device, said communication device comprising MAA elements, and receiving and processing circuits.

In accordance with the principles of this invention a MIMO Receiver device acquires during an implicit stage, out of the scope of the present invention, and prior to the data sub-streams reception process, Channel Matrix information, Symbol Timing, Signal Power Level, Carrier Frequency and any other information typically required by such wireless communication receivers. This information is acquired, or estimated, by means of methods well known to anyone reasonably skilled in the art of communication reception techniques.

In further accordance with the proposed invention the MIMO Receiver device further acquires during or prior to said sub-streams reception process, information regarding the number of simultaneously transmitted complex sub-streams M_{c} and the type of constellation (such as QPSK, 16/64-QAM, etc.) associated with said sub-streams.

Still in accordance with the proposed invention the transmitted vector x_{c} of (1) above is treated as a point which belongs to a Transmission Lattice Bounded Region (e.g. [8]), said Lattice informally defined as an infinite set of regularly spaced points in a multi-dimensional space, and said Lattice Bounded Region informally defined as a closed continuous region in this space (in typical constellations usually of rectangular shape).

In additional accordance with the present invention any noiseless received point H_{c}x_{c} of (1) above is perceived as belonging to a Reception Lattice Bounded Region, said Reception Lattice readily calculable from said Transmission Lattice by application of the Channel Matrix H_{c} as will be clarified in the sequel.

In accordance to this invention, the MIMO reception process incurs the attempt of calculation of the MLD solution point x_{cn} of (3) above, that is a point which belongs to the Reception Lattice, which resides closest (in a Euclidean distance or other suitable sense) to the received point y_{c} of (1) and which is confined to the appropriate Lattice Bounded Region.

In further accordance with the proposed invention a transmitted vector Reception process includes: the calculation of a Reception Initial Lattice Point; a possible sequential Lattice Descent Stage during which, starting from said Reception Initial Lattice Point a descent is executed to sub-sequent Lattice points each calculated to reside at a smaller distance from the received point y_{c} than its previous one, said Descent Stage terminated at a Descent Lattice point for which no closer Reception Lattice point to the received point y_{c} is found (i.e. a minimal point); and an occasional Ascent Stage during which, in cases whereby the Lattice Descent point achieved by said Descent Stage is found to reside out of the Reception Lattice said Bounded Region, an ascent (i.e. an increase in Euclidean distance from the received point y_{c}, or equivalently from said Descent Lattice point) is executed to another Lattice point such that said resulting Lattice point is found to belong to said Lattice Bounded Region and such that its distance from said minimal point is (hopefully) closest than any other point belonging to said Lattice Bounded Region.

### BRIEF DESCRIPTION OF THE DRAWINGS

FIG. 1 describes a typical deployment scenario of a 2-way MIMO Wireless Communication Network.

FIG. 2 provides some characterizations of Lattices and Lattice related entities relevant to the proposed invention.

FIG. 3 shows a Reception Lattice and the associated entities, essential for the exposition of the fore mentioned Lattice Descent Stage and to the fore-mentioned Lattice Ascent Stage.

FIG. 4 presents Reception Lattice views related to the calculation of a Reception Initial Lattice Point.

FIG. 5 presents base-band equivalent Block Diagrams of a Transmitter Device and a Receiver Device of a MIMO Wireless Communication System.

FIG. 6 shows simulated SER vs. Es/No performance results of a particular embodiment of the present invention.

### DETAILED DESCRIPTION OF THE INVENTION

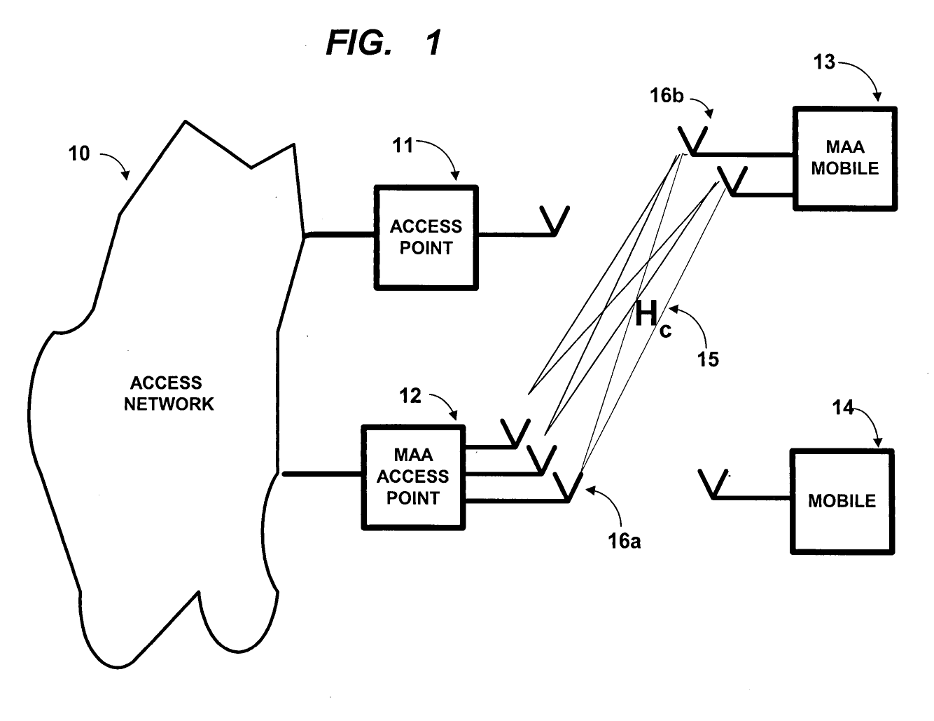

A typical instance of a 2-way Wireless MIMO Network is shown in FIG. 1. According to the present invention such a Network should include at least 2 communication devices, such as 11, 12, 13, or 14, at least one of which should include a MIMO device such as those figuratively represented by 12 or 13. Typically (but not necessarily) a Wire-line access Network 10 (such as a Local Area Network, or a Wide Area Network, or ‘the Internet’, or a Cellular Network Backbone) will be connected to part of the wireless communication devices, such devices usually called Access Points (APs), or Base-Stations, examples of which, 11 and 12, are shown in FIG. 1.

Other wireless communication devices, such as 13 or 14, will stand alone, intercommunicating among themselves, or with the Wire-line Access Network 10, through APs 11 and 12. As further shown in FIG. 1 APs and Mobile Stations alike may comprise a MAA 16 and its associated transmission, reception and processing circuitry, such as devices 12 (an AP) and 13 (a Mobile) in FIG. 1, while others, like 11 (an AP) and 14 (a Mobile) may consist of ‘simple’ non-MAA featured devices.

Between each and every pair of the MIMO Network communication devices a propagation Channel, such as 15, characterizing the propagation effects during signal transmission from 12 to 13 as shown in FIG. 1, may be defined.

The wireless Channel 15 between any two specified devices such as 12 and 13 of FIG. 1, in indoor and urban Network deployments, may typically be described by a complex random R×L matrix H_{c}, where R denotes the number of antennas in the Right, say the Receiving, side, MAA device 13, L denotes the number of antennas in the Left, say the Transmitting, side, MAA device 12, and each element hᵢⱼ in row i and column j of H_{c} defines the (complex base-band) response between reception antenna i of 13 and transmission antenna j of 12.

According to the present invention, H_{c} will be a complex scalar if both communication devices are of ‘simple’ non MAA featured type (such as 11 and 14 in FIG. 1); will be a one-dimensional vector if only one of the devices is MAA featured (such as the pair 11-13 in FIG. 1); and will be a 2-dimensional matrix when both communication devices are MAA featured (such as 12 and 13 in FIG. 1).

In an indoor or urban wireless Network deployment, due to the scattering nature of the propagation channel, the elements of the matrices H_{c} will typically (but not necessarily) be weakly mutually correlated random variables, provided that the MAA elements are properly spaced and designed. In a typical deployment of the proposed invention the Channel Matrix 15 will be quasi static and will only vary negligibly since the time the Channel estimate H_{cn}, assumed to be equal to H_{c} for the sake of simplicity, is made available at the Receiving Side prior to transmission start, and till the end of the transmission burst period.

It will also generally be assumed along this invention description that immediately prior to the data sub-streams transmission, the processes of Signal Power Level, Carrier Frequency and Symbol Timing information estimation and extraction have been completed so that this information is known, down to reasonable accuracy, to the Receiving Side communication device.

It will be convenient (but not essential to the nature of this invention) in the sequel to adopt an all-real number representation of all complex number entities involved; this can be easily achieved by replacing any complex matrix, such as H_{c} by an all-real H

$$H = [ \begin{matrix}{re H}_{c} & - {im H}_{c} \\ im {H}_{c} & re {H}_{c}\end{matrix} ] \qquad ( 4 )$$

of appropriate dimension, and any complex vector, such as x_{c} by

$$x = [ \begin{matrix}re ( {x}_{c} ) \\ im ( {x}_{c} )\end{matrix} ] \qquad ( 5 )$$

and similarly for y_{c} and n_{c}, so that our MIMO system governing equation (1) and our optimal (MLD) detection equation (3) will become, in equivalent all-real notation
y=Hx+n (6)
and
xₙ=arg min ||y−Hₙxᵢ||² (7)
respectively, where the subscript ‘c’ has been omitted to denote an all-real representation. The inverse transformation process, from all-real to complex representation is also readily achieved and omitted herein for the sake of brevity. It can be also readily observed that, applying this all-real notation, the number of all-real data sub-streams is M=2·M_{c}.

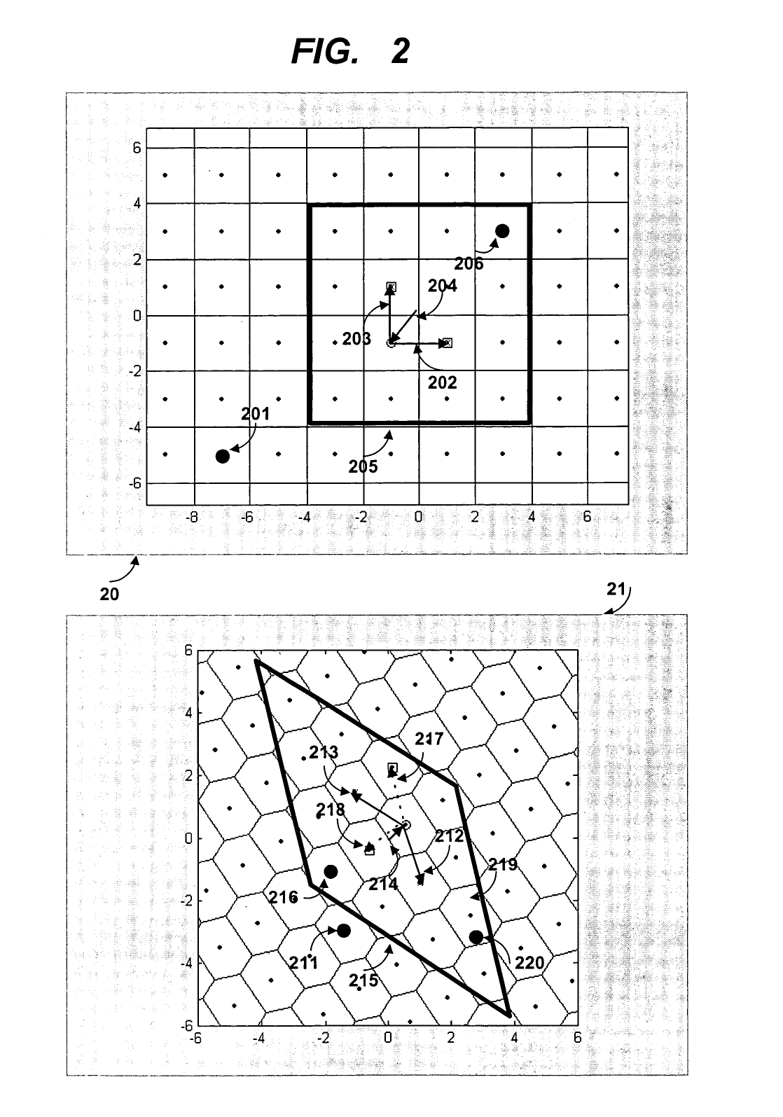

FIG. 2 presents Lattice related entities essential to the exposition of the present invention. A Transmission Lattice suitable for the description of a simple (M=) 2 sub-streams, 4-PAM (Pulse Amplitude Modulation) constellation is depicted in 20 of FIG. 2. Generalization to M>2 sub-streams and to more common constellations such as QPSK, 16-QAM, 64-QAM, etc., is straightforward. Such Transmission Lattices are essentially an infinite set of regularly spaced points in a multi-dimensional space. Any Lattice point x 201 can be conveniently described by means of a linear combination of Basis column Vectors a₁ 202 and a2 203, namely
s=a₀+m₁a₁+m₂a₂=a₀+Am (8)
where m=(m1 m2)′ is any integer vector, A=[a₁ a₂] is a Lattice Generator Matrix and the Lattice Basis Vectors 202 and 203 are a₁=(2 0)′ and a₂=(0 2)′, and where the inconsequential Translation Vector a₀=(−1 −1)′ 204 is added for convenience.

In a typical MIMO communication system transmission constellations are confined to a Bounded Region 205 of a Transmission Lattice 20, such confinement achieved by constraining the integers vector m so that
mₘᵢₙ≦mᵢ≦mₘₐₓ (9)
which in our simple depicted 4-PAM example of 20 take the values mₘᵢₙ=−1 and mₘₐₓ=2. Other constellations, such as QPSK, 64-QAM, etc. result in different values for the constraint (9). A constellation vector s 206 can then be selected for transmission, subject to equation (8) and to constraint (9), and then be used to generate the transmission vector
x=gs (10)
where g is a power normalization scalar, dependent on the number of sub-streams M and on the transmission constellation, applied so that the transmitted vector x maintains unity power as mentioned above.

As can be observed, the Reception Lattice 21 of FIG. 2 is affected by the scaling and rotation effects caused by the random Channel Matrix H on the Transmission Lattice 20 of same Figure. Any point p 211 of the Reception Lattice 21 is expressed by
p=g(H a₀+HAm)=g(b₀+B m) (11)
where B=H A is the Reception Lattice Generator Matrix composed of Reception Basis Vectors b₁ 212 and b₂ 213, and b₀=H a₀ is the Reception rotated-scaled Translation Vector 214.

It can be further observed from 21 of FIG. 2 that the Basis Vectors b₂ 212 and b₂ 213 are no more orthogonal (in contrast to a₁ 202 and a2 203 of 20, which are shown to be orthogonal by virtue of the use of popular constellations), and that the Reception Bounded Region 215 of the Reception Lattice 21 has been also scaled and rotated although still subject to same constraint (9) above so that mₘᵢₙ≦mᵢ≦mₘₐₓ for the Reception Lattice Bounded Region as well.

It should be still further observed that the transmitted constellation vector 206 of 20 described by its integer vector m (aside of its Lattice Generator A) has been transformed in the (noiseless, at this point of the invention exposition) received constellation vector 216 of 21, residing inside the Reception Bounded Region and preserving the same integer descriptive vector m.

The Reception Lattice 21 can be separated into disjoint decision regions (commonly called Voronoi regions), each decision region including all the (real) points that are closer (in a Euclidean distance sense) to a specified Lattice point than to any other Lattice point, one of such Voronoi regions indicated by 219. It is the main function of an optimal (MLD) MIMO receiver to associate any real and noisy received vector y such as 220 of 21 to the closest Reception Lattice point, that is to the Lattice point at the ‘center’ of the Voronoi region to which said received point 220 belongs to.

It should be noted that the scaled-rotated Reception Lattice 21 can be easily ‘de-rotated’ by means of application of the fore-mentioned Inverse Channel transformation of (2) above. However, this ‘de-rotation’ correlates the (originally i.i.d.) elements of the additive noise vector n, distorting the de-rotated Lattice MLD detection metrics; while in the Reception Lattice 21 the MLD detection metrics is the plain geometric Euclidean metrics the de-rotated Lattice MLD detector metrics is a non-Euclidean, so called Mahalanobis, distance (e.g. [9]). Both representations are equivalent and the use of one or the other is not of essence to the proposed invention. The ‘rotated’ Reception Lattice 21 (with its associated Euclidean metrics) will be used in the course of this invention exposition. It is the failure to recognize the properties and detection requirements of this Mahalonabis metrics that deteriorates the fore-mentioned ZF detector so much.

In the context of a preferred embodiment of the proposed invention it will be convenient to describe the Reception Lattice 21 by means of Basis Vectors c₁ 217 and c₂ 218 which are more mutually orthogonal to each other than the original Reception Lattice Basis Vectors b₁ 212 and b₂ 213 as described by the Reception Lattice Generator Matrix B as defined above. Such Basis Vectors usually exist, and are commonly called Reduced Basis Vectors; computationally efficient algorithms for the calculation of such Reduced Basis Vectors have been developed, including the so called LLL Lattice Basis Reduction Algorithm (e.g. [7]). Since said Reduced Basis Vectors depend only on the Channel Matrix H (and not on the transmitted symbol x) they can be calculated only once (per data burst transmission) at a Channel Processing stage.

Since both the original Reception Lattice Generator Matrix B and the Reduced Reception Lattice Generator Matrix C=(c₁c₂)′ describe the same Lattice, then any Lattice point p 211 can be equivalently be expressed by
p=g(b₀+Bm)==g(b₀+Ck) (12)
where k is an integer column vector, and from which the following significant transformations are immediately derived:
m=(B⁻¹C)k=Wk (13)
and
k=(C⁻¹B)m=Vm (14)
where W=(B⁻¹C) and V=(C⁻¹B) can be shown to be integer matrices.

It is a main idea of this proposed invention to solve the MIMO detection problem by means of the solution of an integer (Lattice) Direct Search (e.g. [11]) optimization problem. This solution incurs the selection of an Initial Lattice Point, followed by a Lattice Descent Stage whereby subsequent ‘adjacent’ Lattice Points are selected if their (Euclidean) distance from the real Received Point y is smaller than the distance of the previous Lattice Point from said Received Point, and whereby said Descent Stage is terminated whenever the attempt to identify a closer Lattice Point fails, thereby indicating the probable achievement of a Global Minimum Lattice Point.

It is a second main idea of the present invention to solve the MIMO detection problem by means of execution of a Lattice Ascent Stage during the occasional (but nevertheless non-negligible) cases whereby said Lattice Descent Minimal Point, the said result of said Lattice Descent Stage, is found to reside out of the Reception Lattice Bounded Region 215, such as 211, both of 21. During said Lattice Ascent Stage a Lattice Point residing inside the Bounded Region 215 of 21 is subsequently calculated so that its distance from the Lattice Descent Stage Minimal Point 211 (or, approximately equivalently, from the received point y), is the smallest of all other Lattice Points belonging to said Bounded Region 215. The term ‘Ascent’ is motivated by the fact that said resultant Ascent Stage Lattice Point naturally resides further away from the received point y than said Lattice Descent Minimal Point, indicative of a Lattice ‘ascent’ process. This Ascent Stage can be implemented by a variety of computationally efficient techniques as will be further described below.

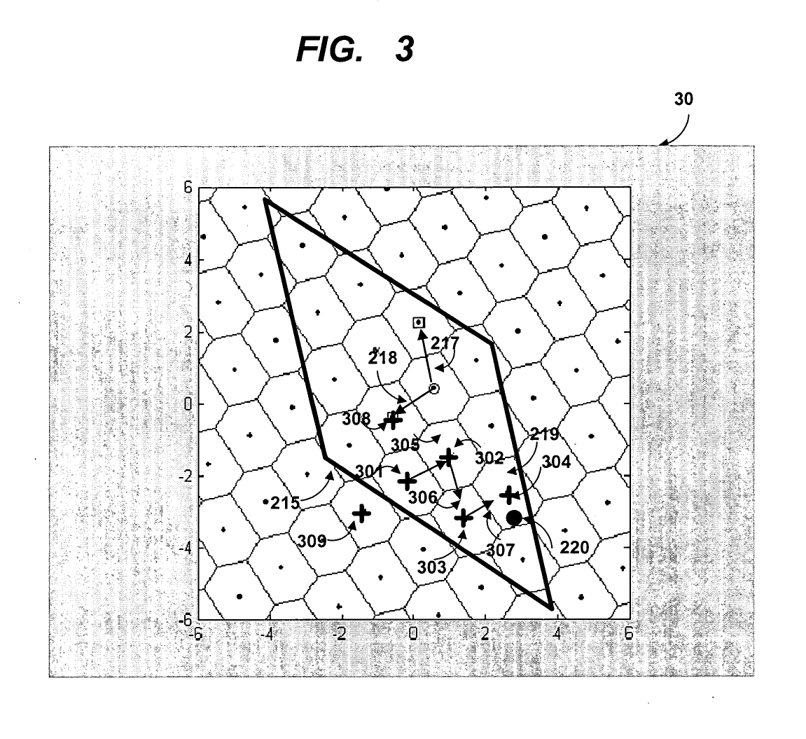

In 30 of FIG. 3 the Reception Lattice entities, essential for the exposition of the fore mentioned Lattice Descent Stage, one of said main ideas of the proposed invention, are depicted. Several entities, introduced in 21 of FIG. 2 are repeated herein, for the sake of clarity, including the Reduced Basis Vectors 217 and 218 (associated with a preferred embodiment of the present invention), the Reception Bounded Region 215, a Received Point y (as per (6) above) 220, and its associated Voronoi region 219. The MLD result after reception of said point y 220 is the Reception Lattice point 304, at the ‘center’ of the Voronoi region 219.

In accordance with a possible embodiment of the proposed invention, it is assumed that an arbitrary Initial Lattice Point, such as 301 of 30 has been selected at the initiation of the Descent Stage.

In further accordance with a possible embodiment of this invention the distance between said Initial Lattice Point 301 and the Received Point 220 is calculated. Following said calculation, candidate Lattice Points, each such candidate derived from the previous (Initial in the first step) Lattice Point by incrementing (or decrementing) the value of a single coordinate kᵢ of the fore mentioned descriptive vector k by a single unit in each of both (positive and negative) directions of the (Reduced) Basis Vectors c₁ and c₂, are calculated. Examples of such candidate Lattice Points, ‘adjacent’ to the Initial Lattice Point 301 in the described way, are 308, 309, and 302 of 30. In the depicted simple case of a (real, M=2) M-dimensional Lattice, carrying M (real) data sub-streams and spanned by M (Reduced) Basis Vectors, 2M (=4 in this case) such candidates exist. In general, the number of candidate Lattice Points at each stage grows, according to this proposed invention, linearly with the M, the dimension of the problem.

In a possible embodiment of this invention the distances between each of these 2M candidates (of which 308, 309, and 302 are marked in 30) and the Received Point 220 are calculated, and a candidate Lattice Point is selected, 302 in this example, with the smallest distance (of all considered candidates) from the Received Point 220.

The Lattice Point 302 becomes effectively a new Initial Lattice Point and the process is repeated, sequentially selecting, in our example, Lattice Points 303 and 304 corresponding to the unit direction vectors 306 and 307 of 30. The Descent Stage is then terminated, since, following arrival to 304 no unit direction vector yields a candidate Lattice Point with smaller distance to 220 than 304 itself, indicating the arrival to a Lattice Minimum Point.

Said Lattice Minimum Point can be a true Minimum Point, i.e. a point such that no other Lattice Point is closer to the Received Point y than said Minimum Point, or it may turn out to be a false Minimum Point, that is a point that, because of the restricted direction vectors utilized during said Descent Stage (for example the original Basis Vectors b₁ and b₂), results in termination of said Descent Stage in some Lattice Point other than the true Minimum Point.

In a preferred embodiment of the present invention said specific set of selected direction-vectors is a Reduced Basis Vector set such as 217 and 218 of 30 as defined above, i.e. a minimal set of relatively short and orthogonal vectors which span the Reception Lattice, thus reducing the probability of false Minimum Points as described.

In still other embodiments of the proposed invention, the original (non-reduced) Basis Vectors b₁ and b₂ constituent of the Reception Lattice Generator Matrix B can be used.

In still other embodiments of this invention other sets of vectors, which span the Lattice but do not necessarily constitute a basis (i.e. are not necessarily a minimal set of vectors) can be used.

In the context of a preferred embodiment of the proposed invention the concept of a Lattice Directional Differential is introduced, a sort of lattice discrete counterpart to the continuous world Directional Derivative (e.g. [12]). While it is possible, according to some embodiments of the proposed invention, to conduct explicit Euclidean distances calculation at each stage, as depicted above, the application of this concept will allow a more computationally efficient calculation and selection of best candidate Lattice Points.

The (Euclidean squared) distance d(p,y) between a Received Point y (such as 220 of 30) and an arbitrary Lattice Point p=b₀+C k (such as 301 of 30) is readily expressed as
d(p,y)=(y−p)′(y−p)=y′y−y′Ck−k′C′y (15)
A unit column vector eᵢ is next defined so that it contains zeroes in all its elements except the ‘i’ element which is valued +1 or −1 alternatively, i.e. eᵢ=(0 0 . . . +/−1 0 . . . 0)′. An adjacent Lattice Point q (‘adjacent’ to our previous point p) is then q=C(k+eᵢ) so that said Lattice Directional Differential defined by D(q,p)=d(q,y)−d(p,y) can now be expressed (after some manipulation) as
D(q,p)=(2k′(C′C)−2y′C)eᵢ+eᵢ′(C′C)eᵢ (16)
which is simply the signed sum of the ‘i’ element of the (2k′(C′C)−2y′C) row vector and the ‘i’ diagonal element of the (C′C) matrix which can be pre-calculated just once at each selected new Lattice Point and at each new Channel Processing stage respectively.

In a preferred embodiment of this invention, at the Initial Lattice Point as well as at each of its subsequent successors, the Lattice Directional Differentials as defined by (16) are calculated for each possible vector-direction, and the next Lattice Point is selected such that its corresponding Lattice Directional Differential yields the most negative result (in other embodiments of this invention the first found negative Lattice Directional Differential may be used). The Descent Stage ends then, once all Lattice Directional Differentials are non-negative, indicative of the arrival to a Lattice Minimum Point.

In other possible embodiments of the proposed invention the new selected Lattice Point is calculated by means of the linear combination of all the vector-directions that yielded a negative Lattice Directional Differential or, equivalently, a reduced distance from the Received Point y.

It should be evident by now from the previous description that the complexity of the proposed MIMO detection method depends also on the proper selection of the Initial Lattice Point 301 of 30. The closer this Initial Point is selected to the MLD optimal solution, the less steps are required in order for the previously described Descent Stage to converge to that solution. In the context of a preferred embodiment of this proposed invention the Initial Lattice Point is the Rounded Parallelepiped Projection of the Received Point y on each of the Lattice Basis Vectors as described below.

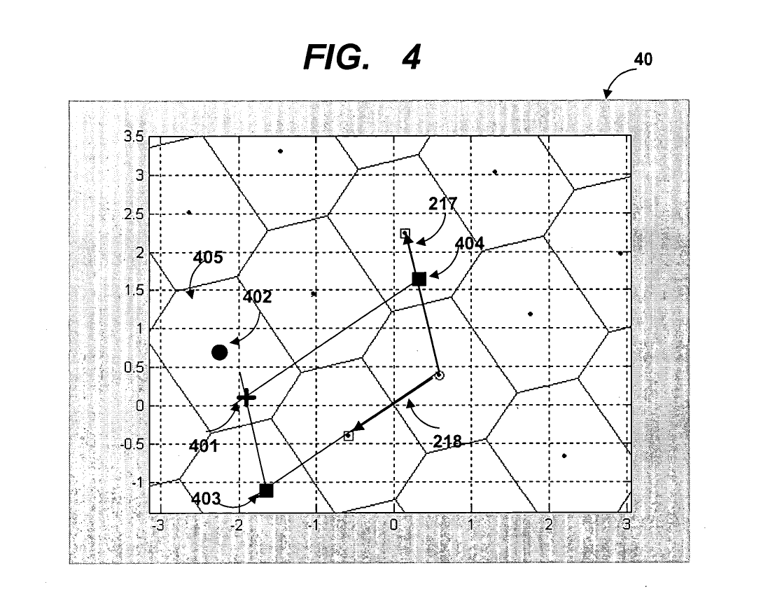

FIG. 4 depicts a zoomed-in view of the Reception Lattice 40 in the context of the selection of an Initial Lattice Point in a preferred embodiment of this invention. The Reduced Basis Vectors c₁ 217 and c₂ 218, i.e. the column vectors of the Reception Lattice Generator Matrix C, are repeated in this drawing in the context of the Rounded Parallelepiped Projection concept introduced herein. We assume the reception of a vector y 401. Since this vector 401 belongs to the Voronoi region 405 the optimal MLD detector will decide that the transmitted symbol is the Lattice Point 402 which can be easily seen to be described by k=(1 2)′.

In order to calculate the Rounded Parallelepiped Projection of Received Vector 401 a dimension, say c₁, is first selected and a hyper-plane spanned by all the other dimensions (only c₂ in our simple example), and passing through the Received Vector 401 is expressed by (y+h₂ c₂) where h₂ is a (not necessarily integer) scalar parameter.

We now proceed to calculate the intersection of said hyper-plane and the selected dimension-vector 217 c₁. All points in this direction are expressed by (b₀+h₁c₁) where h₁ is, again a (not necessarily integer) scalar parameter. Hence the intersection between said hyper-plane and said dimension-vector is expressed by (y+h₂c₂)=(b₀+h₁c₁) which is readily solved for h=(−h₁h₂)′ to yield
h=C⁻¹(b₀−y) (17)
This process is repeated for the other dimensions (only c₂ 218 in our simple case) to find each of the other intersection points. It should be noted that, in practice, (17) needs to be resolved only once, and the required parameter is extracted by negating the corresponding scalar parameter hᵢ.

The Rounded Parallelepiped Projection of our Received Vector y 401, i.e. the Initial Lattice Point k₀ is then
k₀=−round(h) (18)
where ‘round’ is the rounding (to the nearest integer) operator.

By inspection of the geometry of 40 of FIG. 4 it can be seen that the Rounded Parallelepiped Projection process yields in this specific case the Lattice Point k₀=(1 2)′ identical to the MLD detected Lattice Point 402. Although this is the (happy) case in the majority of instances, there are cases (not shown in FIG. 4) whereby the resulting Rounded Parallelepiped Projection k₀, differs from the MLD solution (but is usually very close to it). The fore-mentioned Lattice Descent stage attempts (usually successfully) to converge to said MLD solution in these cases.

In a preferred embodiment of our proposed invention the Initial Lattice Point is the result of the Rounded Parallelepiped Projection computation (18) as described above.

In other embodiment of the present invention said Initial Lattice Point can be the (rounded) Inverse Channel or ZF solution (2) as described above.

In still other embodiment of the proposed invention said Initial Lattice Point can be the (rounded) result of some other estimator such as the MMSE solution as mentioned above.

In still other embodiment of the proposed invention said Initial Lattice Point can be the (rounded) orthogonal projection of the Received Vector 401 onto each of the direction-vectors.

In still other embodiment of the proposed invention said Initial Lattice Point can be a fixed Lattice point, such as the Lattice origin.

We refer again to 30 of FIG. 3 in order to describe aspects and embodiments of the fore-mentioned Ascent Stage of this proposed invention. As mentioned above the result of the Lattice Descent Stage may be a Lattice Point residing out of the Reception Bounded Region 215. Such an example of an ‘Outlying’ Lattice Point 309 is shown in 30 of FIG. 3. As it turns out this erroneous Descent Lattice Point decision may happen occasionally, but still with non-negligible probability, depending on the specific Reception Lattice (i.e. on the Channel Matrix H), on the selected Constellation type (e.g. QPSK, 16-QAM, etc.) and on the average Reception SNR. Detection of such a point as 309 as the hypothetically transmitted Lattice Point is obviously illegal since transmitted Lattice Points are confined to the Bounded Region 215 by virtue of the inequality constraint (9) above.

The legal Maximum Likelihood Decision in such cases would be a Lattice Point closest to the received point y (and usually equivalently closest to the selected Descent Stage Lattice Point 309) but residing within the Bounded Region 215. Such a point, in our example, would be 301. Several Lattice Ascent methods can be applied, with varying degrees of SER performance and complexity as will be presently described.

It should be noted herein that in the context of the present invention, due to the typically low frequency of occurrence of these Outlying Lattice Points, complexity of the Ascent Stage has relatively small impact on the average complexity (i.e. average number of operations per symbol) of a MIMO Receiver device.

In the context of a possible embodiment of the Lattice Ascent Stage of the present invention convenient metrics functions describing the distance between an Outlying Lattice Point, such as 309, and the Lattice Bounded Region 215 (denoted by R below) can be defined. For any Lattice Point p=g(b₀+Bm)==g(b₀+Ck) as defined by (12) above one possible simple metrics function could be

$$\begin{matrix}{d}_{i} ( p , R ) = \{ \begin{matrix}\vert {m}_{i} - {m}_{min} \vert , & {m}_{i} < {m}_{min} \\ 0 , & {m}_{min} \leq {m}_{i} \leq {m}_{max} \\ \vert {m}_{i} - {m}_{max} \vert , & {m}_{i} > {m}_{max}\end{matrix} \\ and & ( 19 a ) \\ d ( p , R ) = \sum {d}_{i} ( p , R ) & ( 19 b )\end{matrix}$$

Another possible convenient metrics function could be
d(p,R)=max dᵢ(p,R) (19c)
with dᵢ(p,R) defined by (19a) above.
Other convenient metrics functions suitable to describe the distance between a Lattice Point and an associated Bounded Region R can be devised.

In a possible embodiment of the proposed invention, for resulting Lattice Descent Stage Points such as 309 found to reside outside the Bounded Region 215, a Lattice Ascent Stage is initiated. In further accordance with a possible embodiment of the present invention, starting from said point 309, different possible directions are generated by single coordinate increments (or decrements) of Lattice vectors (in a similar fashion to the Lattice Descent Stage method as described above); for each such resulting new candidate Lattice Point the metrics function (as per (19b) or (19c) above) is evaluated and a set of ‘winning’ or ‘survivor’ Lattice points are selected based on the largest decrease (or the smallest increase) in d(p,R). The resulting set of points is the starting point for a new iteration whereby each vector coordinate is incremented (decremented) and its metrics function is evaluated. This iterative process is terminated once a Lattice point is generated for which d(p,R)=0. The process may be also aborted if, after a predetermined number of iterations, no Lattice Point for which d(p,R)=0 is found. The resulting Lattice Point is our Ascent Stage result and our final Vector-Symbol Decision.

In accordance to another possible embodiment of the proposed invention the Lattice Ascent Stage is resolved by solving the Integer Quadratic Programming problem
min(m−m_{d})′B′B(m−m_{d}) (20a)
subject to
mₘᵢₙ≦mᵢ≦mₘₐₓ (20b)
or, similarly
min(k−k_{d})′C′C(k−k_{d}) (20c)
subject to
mₘᵢₙ≦(Wk)₁≦mₘₐₓ (20d)
where the minimization is executed over all m (or equivalently, k), where m_{d} (or k_{d}) denotes the (Outlying) Lattice Descent Stage result, and where the functional (20a) (or (20c)) above defines the Euclidean distance between a general Lattice point and the Lattice Descent Stage result. Integer Quadratic Programming constrained optimization problems are considered classic optimization problems and can be solved by a variety of methods by those reasonably skilled in the art (e.g. [10]).

In still another possible embodiment of the proposed invention the Lattice Ascent Stage is solved by calculation of a subset of the Lattice Nearest Neighbor points according to their ascending distance from the Lattice Descent Stage point. Because of the inherent regularity of lattices, said sorted Lattice Nearest Neighbors Table can be pre-calculated during the Channel Processing Stage, whereby distances would be referred to a general, ‘any’ Lattice Point. During the Symbol Processing Stage the Lattice Nearest Neighbors Table points can be evaluated, in sequential order, this time referred to the Lattice Descent Stage result m_{d} (or k_{d}). The first such evaluated Lattice Point that is found to reside within the Lattice Bounded Region 215 terminates the process. If no such point is found till the end of said Lattice Nearest Neighbors Table points evaluation, then the process may be aborted. Enumeration of said ascending distance Lattice Points can be easily (though approximately) executed by means of e.g. Combinatorial Enumeration of vectors based on the fore-mentioned Reduced Basis Vectors, by anyone reasonably skilled in the art. In this context it should be noted that, under useful average Reception SNR conditions, the distance (as defined by e.g. (19) above) between practically found Outlying Lattice points, such as 309, and the Lattice Bounded Region 215 is usually small so that the fore-mentioned enumeration process, and resulting Lattice Nearest Neighbors Table is reasonably short and computationally efficient.

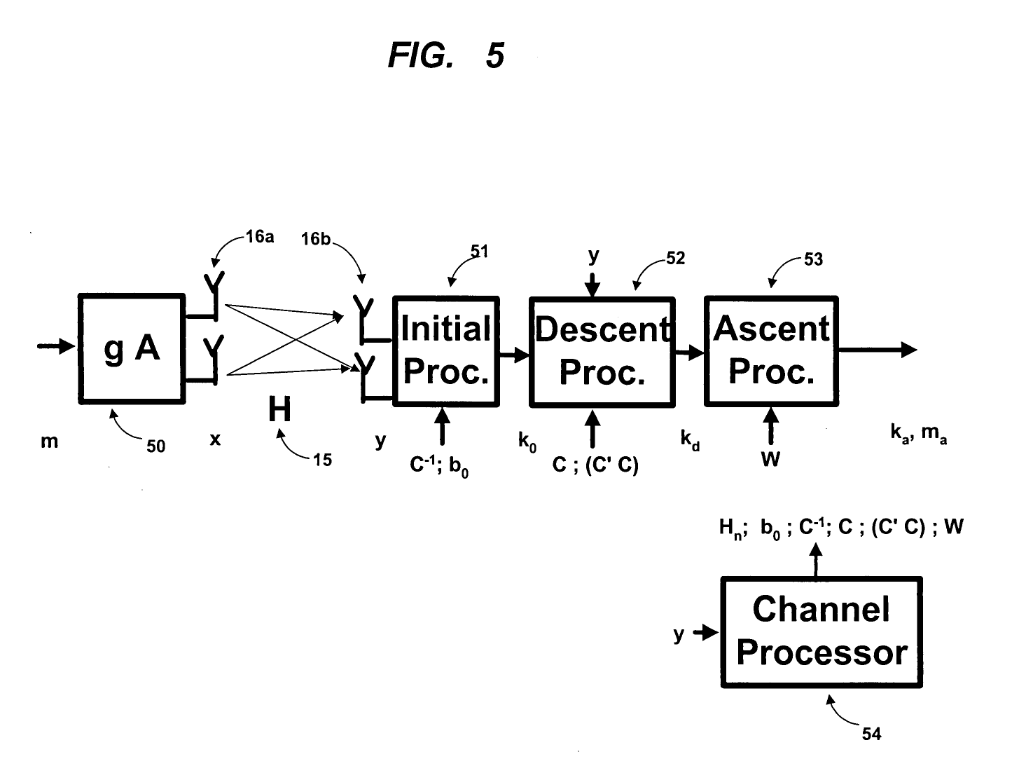

FIG. 5 depicts a base-band equivalent Block Diagram of a MIMO Wireless Communication System comprising a Transmission Device 50 and its associated MAA 16a, a Propagation Channel 15, and a Reception Device consisting of an Initial Point Processor 51, a Descent Stage Processor 52, an Ascent Stage Processor 53, a Channel Processor 54 and the Reception Device associated MAA 16b. Across the Block Diagram of FIG. 5 entities are notated in their corresponding all-real representation in accordance with (4) and (5) as described above.

All processing elements to be described in the context of FIG. 5 can be efficiently implemented by means of Digital Signal Processing hardware or software using well known techniques by those skilled in the art. Transmission and Reception Devices usually include additional physical elements and circuits such as radiating elements (Antennas), Radio Frequency (RF) Amplifiers, Frequency Translators, Analog to Digital Converters (ADCs) and Digital to Analog Converters (DACs), etc., all essential to the operation and feasibility of such devices but immaterial to the subject and ideas of this proposed invention, and therefore have been omitted from this detailed description.

The Transmission Device 50 of FIG. 5 accepts a traffic data sub-streams vector given in terms of its constellation coordinates m, and generates a power normalized transmission vector x=g(a₀+Am) in accordance with (8) and (10) above.

The transmission vector x is radiated by means of the Transmission Device 50 associated MAA 16a, propagated through the transmission (scattering, distorting and noisy) Channel 15, and received by the Reception Device associated MAA 16b, resulting in the Reception Lattice Point y=Hx+n in accordance with (6) above.

It is assumed, as is generally the case in digital Wireless Communication Systems, that data transmission is preceded by a preamble transmission during which the Reception Device Channel Processor 54 estimates the propagation Channel H 15, resulting in a Channel Estimate Hₙ which is herein assumed, for the sake of simplicity and without essential impact on our proposed invention, to be equal to the actual Channel 15, i.e. H=Hₙ; said Channel estimation conducted by an implicit estimation method, such as LSE, MMSE or other, methods well known to those reasonably skilled in the art. It is further implicitly assumed that said Channel Processor 54 acquires an additional set of necessary information such as average Signal Power Level, Signal Carrier Frequency and Symbol Timing, not shown in FIG. 5.

Said Channel Processor 54 of FIG. 5, following said estimation of Channel information and said other mentioned required entities, and in accordance with a preferred embodiment of the proposed invention, proceeds to calculate some of this invention related entities including: b₀, the distorted Lattice translation vector; C the Reduced Basis Generator Matrix; C⁻¹, (C′C), artifacts of said Reduced Basis Generator Matrix; and W, the fore-mentioned transforming matrix from k coordinates to m coordinates. Said calculations are carried out with the auxiliary implicit participation of some additional information, assumed w.1.o.g. to be available at both the Reception and Transmission Devices such as: A, the Constellation Generator Matrix, the Constellation order, i.e. mₘᵢₙ and m_{max,} etc.

In accordance with a preferred embodiment of the present invention, the Initial Point Processor 51 of FIG. 5 calculates the coordinates k₀ of the Lattice Initial Point by means of the Rounded Parallelepiped Projection of the Received Vector y, in accordance with (17) and (18) as described above.

In further accordance with a preferred embodiment of this present invention the Descent Stage Processor 52 of the Reception Device accepts said Initial Point coordinates k₀, said Received Vector y, and said Channel Processor 54 results C and (C′C), and proceeds to iteratively calculate Lattice Directional Differentials according to (16) above, and subsequent Lattice Points until arrival to a Lattice Minimum Point with coordinates k_{d} as described above.

In accordance with a preferred embodiment of the proposed invention following said k_{d} calculation, the original Lattice Basis coordinates m_{d}=Wk_{d} of said Lattice Minimum Point are calculated in the Ascent Stage Processor 53 according to (13) above, and a test regarding the residence of said Lattice Minimum Point m_{d} inside the Lattice Bounded Region (215 of FIG. 2) is carried out according to (19) as described above. In the most frequent cases whereby the Lattice Minimum Point m_{d} is found to belong to the Lattice Bounded Region as defined by (9) above then further processing by the Ascent Stage Processor 53 is not necessary. The symbol processing ends at this stage with the decision mₐ=m_{d} (and, equivalently kₐ=k_{d}).

In the occasional, but still not negligible, cases whereby said Lattice Minimum Point m_{d} is found to reside outside said Lattice Bounded Region, i.e. does not satisfy (9) above for at least some elements m_{di} then an Ascent Stage is conducted whereby the Lattice Point closest to m_{d} but belonging to the Lattice Bounded Region is searched for. This search is conducted on the Ascent Stage Processor 53 by means of the application of any of the methods proposed in the corresponding paragraphs above, namely Direct Search by iterative application of (19), Integer Quadratic Programming following (20) above, or Lattice Nearest Neighbors Table enumeration as also described above. The Ascent Stage symbol-vector decision result, denoted kₐ, with its corresponding mₐ, is then made available to the user.

The implementation complexity analysis of a MIMO Reception Device made in accordance with a preferred embodiment of our proposed invention can be sub-divided into a complexity analysis of the Channel Processing stage which usually takes place at the beginning of each transmission burst (sometimes called Training Stage), implemented by means of the Channel Processor 54 of FIG. 5, and of the Symbol Processing stage, implemented by means of the Initial Point Processor 51, Descent Stage Processor 52 and Ascent Stage Processor 53 all of FIG. 5.

The MIMO specific operations executed by the Channel Processor 54 include the Channel Matrix H estimation, and the computation of several other shown matrices and vectors. Most said calculations scale up quadratically with the dimension of the MIMO system, i.e. M, and do not depend on the constellation order. The Reduced Basis calculation (computation of the matrix C) is known to scale up polynomially with the dimension of the problem (e.g. [7]).

Due to its usual repetitive nature the Symbol Processing stage complexity is of major significance to the overall Reception Device average complexity. In accordance with a preferred embodiment of the current invention the calculation of the Lattice Initial Point implemented in the Initial Point Processor 51 involves a matrix-vector multiplication (as per (17) above) that scales quadratically with M, and a vector rounding operation (as per (18) above) that scales linearly with M; both are independent of the constellation order.

In further accordance with a preferred embodiment of our proposed invention the calculation of the Lattice Minimum Point, carried out in the Descent Stage Processor 52, incurs the iterative calculation and evaluation of Lattice Directional Differentials following (16) above, said calculation and evaluation scaling up quadratically at most with M, as can be easily verified by inspection of (16), and again independent of the constellation order. Simulation results show that the number of iterations involved is relatively low, in particular when the Lattice Initial Point is calculated in accordance with our preferred embodiment method (i.e. Rounded Parallelepiped Projection) as mentioned above.

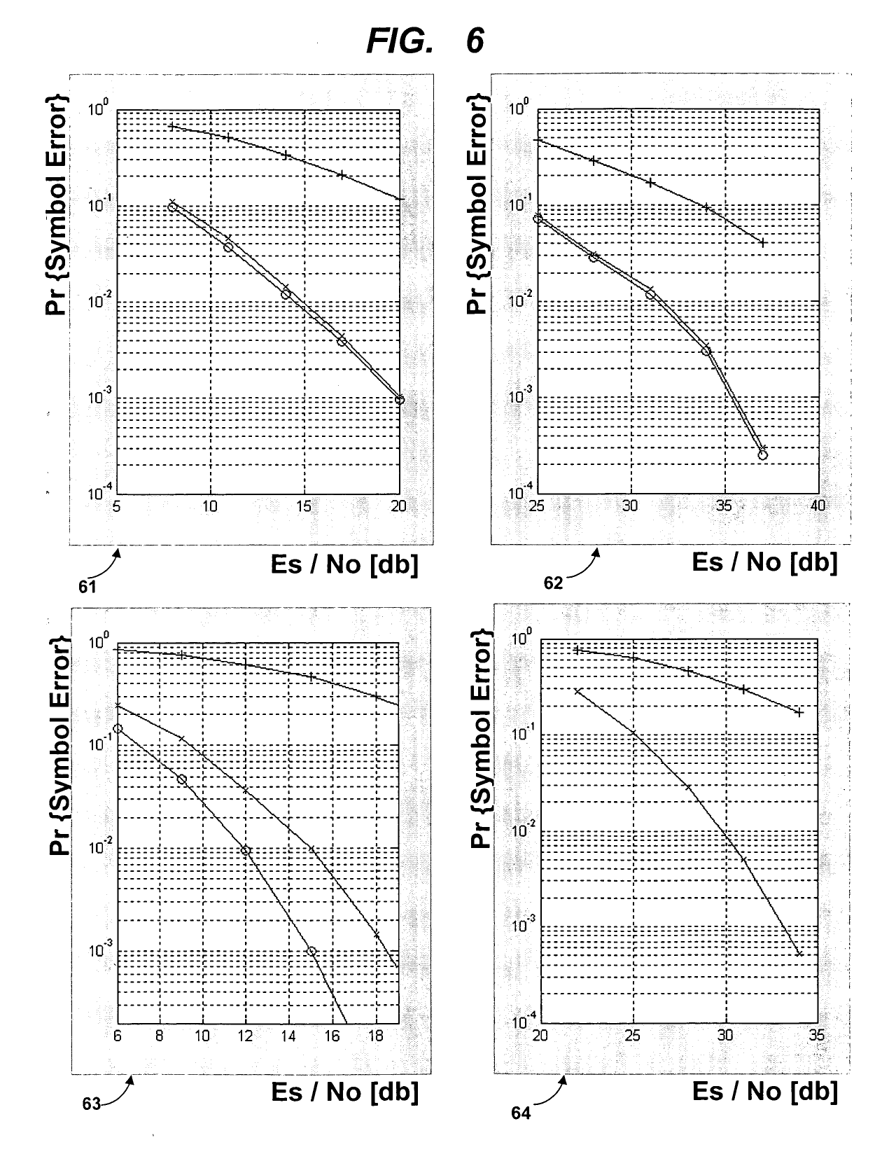

An actual activation of the Ascent Stage Processor 53 is effected only occasionally, at those events whereby the resulting Lattice Minimum Point (as calculated by the Descent Stage Processor 52) is found to not to belong to the Bounded Region 215 of FIG. 2. Simulation results show again, that the probability of these events is low; for example, at a typical SER=1E−3 operating point these probabilities are in the order of 3E−3 to 1E−4 for the cases {QPSK, M_{c}=2} to {64-QAM, M_{c}=4} as shown in 61 to 64 (as described below) of FIG. 6 respectively. Hence, in general, their average complexity impact on the Symbol Processing Stage is relatively mild. Notwithstanding with the above, and for purpose of example, the implementation of an Ascent Stage Processor 53 in accordance the iterative Direct Search method and its associated metrics (19) as described above can be easily shown to be of similar complexity of that of the proposed Descent Stage Processor 52, namely quadratic at most with the dimension of the MIMO problem dimension M and independent of the constellation order.

FIG. 6 presents SER vs. Es/No comparative plots, 61, 62, 63 and 64 of the simulated performance of a MIMO system implemented by a variety of methods, for several constellation orders and number of sub-streams. In 61 of FIG. 6 the performance of a QPSK constellation with L=R=M_{c}=2 is provided. In 62 of FIG. 6 the performance of a 64-QAM constellation with L=R=M_{c}=2 is provided. In 63 of FIG. 6 the performance of a QPSK constellation with L=R=M_{c}=4 is provided. In 64 of FIG. 6 the performance of a 64-QAM constellation with L=R=M_{c}=4 is provided. In all said plots the Symbol Error Rate of a selected data sub-stream is shown (all data sub-streams are expected to yield similar SER performance due to the symmetry of the problem).

In said plots the SER vs. Es/No performance curves achieved by MIMO systems implemented by the methods presented in this proposed invention is denoted by ‘x’. For reference and comparative purpose all plots also show the SER vs. Es/No performance curves achieved by means of the fore-mentioned (naïve) Inverse Channel or Zero Force detection schemes which solve the MIMO problem in accordance with (2) above. These are denoted by ‘+’. In all said plots, except 64 of FIG. 6, the SER vs. Es/No performance curves of the optimal MLD method as described by (3) above are also shown, again for reference purpose, denoted by ‘o’. This curve is omitted for 64 of FIG. 6 given the enormous complexity incurred (approximately 16000000 operations per symbol as mentioned above).

The enormous processing gain of our proposed method relative to the ZF reference method can be readily noticed. Our proposed method is seen to perform at quasi-optimal level (i.e. quite close to the optimal MLD curves) in both 61 {M_{c}=2, QPSK} and 62 {M_{c}=2, 64-QAM} of FIG. 6. For greater problem dimensions such as in 63 {QPSK, M_{c}=4} of FIG. 6 performance is also excellent, with a performance gap of only about 3 db (at SER=1E−3) relative to the optimal MLD bound.

What is claimed is:

1. In a wireless communication system, when at least some of the system communication devices include several radiating elements and their associated transmitting and receiving circuitry, when several parallel user data sub-streams are transmitted simultaneously between a transmitter and a receiver side, and when a scattering and additively noisy propagation channel is present between said transmitter and receiver sides; a reception method where the transmitted point of said sub-streams is treated as a point which belongs to a bounded region of a lattice, where the noiseless received point is treated as a point which belongs to a bounded region of a transformed lattice, said lattice transformation being caused by said propagation channel, and where the actual received point is the result of said noiseless received point further disturbed by said channel additive noise, where said received lattice is described by means of a set of spanning vectors, and whereby said reception includes: the selection of an initial received lattice point; an iterative sequential selection of successive received lattice points, starting from said initial point, each successive lattice point so selected that its distance from said actual received point is smaller than the distance of the preceding lattice point from said actual received point; and a termination act whereby said iterative sequential selection is terminated when no such point, nearer to the actual received point than its preceding lattice point is found.

2. The method of claim 1 where said set of spanning vectors is a basis vectors set.

3. The method of claim 2 where said basis vectors set is a reduced basis vector set.

4. The method of claim 1 where said iterative sequential selection of successive received lattice points is conducted by calculation of the measure of increase or decrease of the distance of the preceding lattice point from said actual received point, rather than calculating the absolute distance (or square of said distance) itself.

5. The method of claim 1 where during said iterative sequential selection of successive received lattice points, each successive lattice point is calculated by an increment or decrement of one or more steps, said increments or decrements executed upon one or more selected vectors of said spanning vector set.

6. The method of claim 1 where said initial received lattice point is the rounded parallelepiped projection of the actual received point upon each of the vectors belonging to said spanning vector set.

7. The method of claim 1 where said initial received lattice point is the rounded orthogonal projection of the actual received point upon each of the vectors belonging to said spanning vector set.

8. The method of claim 1 where said initial received lattice point is a selected fixed point.

9. The method of claim 1 where said initial received lattice point is a random selected point.

10. The method of claim 1 where the coordinate system by means of which said received lattice is described is the transmission lattice coordinate system rotated by the channel matrix of said propagation channel, and whereby distances between received lattice points and said actual received point is the Euclidean distance.

11. The method of claim 1 where the coordinate system by means of which said received lattice is described is the transmission lattice coordinate system rotated and scaled by the channel matrix of said propagation channel, further de-rotated and de-scaled by the inverse of said channel matrix, so that the resulting coordinate system equals the original said transmission lattice coordinate system and whereby distances between received lattice points and said actual received point is the Mahalonabis distance.

12. The method of claim 1 where the matrix and vector entities involved in description of said transmitted lattice points, said propagation channel, said received lattice points and said other entities are represented by means of all-real representations.

13. The method of claim 1 where for lattice points resulting from said terminated iterative sequential selection of successive received lattice points which do not belong to said received lattice bounded region, an additional reception stage is included whereby a received lattice point belonging to said bounded region and which is closest to said result of said terminated iterative sequential selection is calculated.

14. The method of claim 13 whereby said calculation of said received lattice point belonging to said bounded region and which is closest to said result of said terminated iterative sequential selection is conducted by iterative sequential selection of successive received lattice points, whereby each selected point yields maximal decrease or minimal increase of distance from said received lattice bounded region, and whereby said iterative sequential selection is terminated after either a received lattice point is arrived to, which belongs to said received lattice bounded region, or after failure to arrive to such said point after a determined number of iterations.

15. The method of claim 13 whereby said calculation of said received lattice point belonging to said bounded region and which is closest to said result of said terminated iterative sequential selection is conducted by means of the solution of an integer quadratic programming optimization problem.

16. The method of claim 13 whereby said calculation of said received lattice point belonging to said bounded region and which is closest to said result of said terminated iterative sequential selection is conducted by means of search of an ordered by ascending distance (or approximately ordered) lattice nearest neighbors table, said table more conveniently being pre-calculated during a channel processing stage, and whereby said search is terminated after either a received lattice point is arrived to, which belongs to said received lattice bounded region, or after failure to arrive to such said point after the complete search of said table.

17. In a wireless communication system, where at least some of the system communication devices include several radiating elements and their associated transmitting and receiving circuitry, where several parallel user data sub-streams are transmitted simultaneously between a transmitter and a receiver side, where a scattering and additively noisy propagation channel is present between said transmitter and receiver sides, where the transmitted point of said sub-streams is treated as a point which belongs to a bounded region of a lattice, where the noiseless received point is treated as a point which belongs to a bounded region of a transformed lattice, said lattice transformation being caused by said propagation channel, and where the actual received point is the result of said noiseless received point further disturbed by said channel additive noise; a reception apparatus comprising means for calculation of a received lattice initial point, and further comprising means for iterative sequential selection of successive received lattice points, starting from said initial point, each successive lattice point so selected that its distance from said actual received point is smaller than the distance of the preceding lattice point from said actual received point; and means to terminate said iterative sequential selection when no such point, nearer to the actual received point than its preceding lattice point is found.

18. The reception apparatus of claim 17 comprising means to evaluate whether said result of said terminated iterative sequential selection of received lattice points belongs, or does not belong, to said received lattice bounded region, and comprising further means to calculate, for those said results found to not to belong to said received lattice bounded region, another received lattice point which belongs to said received lattice bounded region and which is nearest, of all received lattice points, to said result of said terminated iterative sequential selection of received lattice points.
